(19) United States
(12) Patent Application Publication
(10) Pub. No.: US 2018/0341709 A1
(43) Pub. Date: Nov. 29, 2018

(54) UNSTRUCTURED SEARCH QUERY GENERATION FROM A SET OF STRUCTURED DATA TERMS

(71) Applicant: LONGSAND LIMITED, Cambridge (GB)

(72) Inventor: George SAKLATVALA, Cambridge (GB)

(73) Assignee: LONGSAND LIMITED, Cambridge (GB)

(21) Appl. No.: 15/529,463

(22) PCT Filed: Dec. 2, 2014
(86) PCT No.: PCT/EP2014/076251

§ 371 Date: May 24, 2017

(51) Int. Cl. G06F 17/30

(52) U.S. Cl. CPC G06F 17/30867; G06F 17/30967; G06F 17/30979

(57) ABSTRACT

A system may include query circuitry. The query circuitry determine a set of structured data terms relevant to a specific data type by performing a preconfigured query for the specific data type on a structured dataset. The preconfigured query may be generated according to a predefined business rule for the specific data type. The query circuitry may further generate an unstructured search query from the set of structured data terms and execute the unstructured search query on an unstructured dataset to obtain unstructured search results.

### BACKGROUND

Recent advances in technology have spurred the generation and storage of immense amounts of data. Web search engines support searching of huge amounts of data scattered across the Internet. Corporations may generate immense amounts of data through financial logs, e-mail messages, business records, and the like. High definition video files may encode vast amounts of audio and video data. As technology continues to develop, search and analysis of relevant data among large data sources may become increasingly difficult.

### BRIEF DESCRIPTION OF THE DRAWINGS

Certain examples are described in the following detailed description and in reference to the drawings.

FIG. 1 shows an example of a data system that supports accessing structured data, unstructured data, or both.

FIG. 2 shows an example access to a structured dataset that query circuitry may perform.

FIG. 3 shows an example access to an unstructured dataset that the query circuitry may perform.

FIG. 4 shows an example of data joining that the query circuitry may perform.

FIG. 5 shows an example of a data analysis that the query circuitry may perform.

FIG. 6 shows an example of a data insertion that the query circuitry may perform.

FIG. 7 shows an example of logic that the query circuitry may implement.

FIG. 8 shows an example of a computing device that supports accessing of structured data, unstructured data, or both.

### DETAILED DESCRIPTION

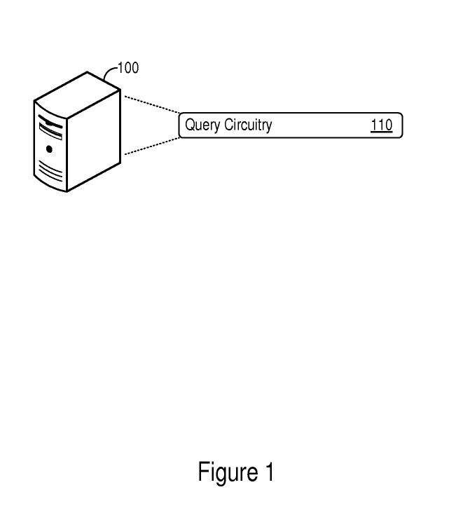

FIG. 1 shows an example of a data system 100 that supports accessing structured data, unstructured data, or both. Structured data may refer to data that follows a fixed data model or schema. Structured data may thus be stored in fixed fields within a record or file, as specified by the data model. Examples of structured data may thus include data stored as part of a relational database, fixed spreadsheet field, an extensible markup language (XML) file, data warehouse storage, enterprise system record, accounting record, statistical storage, sensor record, web log, financial transaction log, or as part of a dataset according to any specific data model or data schema. A set of structured data may be referred to as a structured dataset. As one particular example, the data system 100 may access a structured dataset implemented as a relational database.

Unstructured data may refer to data that does not follow a fixed data model or schema. In that regard, unstructured data may not be stored in a particular fixed location as set forth by the data model. In that regard, unstructured data may refer to free form text or data that is not stored in a predetermined field of a data file. Unstructured data may also be referred to as an unstructured document, and a data file may include multiple unstructured documents or an unstructured document may span across multiple data files. Unstructured documents may thus found in text or word processing documents, web pages, social sites, image files, e-mail messages, digital audio and/or video files, and more. A set of unstructured data may be referred to as an unstructured dataset, and the data system 100 may access an unstructured dataset through an unstructured data management system, such as a search engine. The search engine may index unstructured documents to support efficient access and searching of unstructured data.

The data system 100 may include query circuitry 110 that implements various functionality with regards to accessing of the structured and/or unstructured data. The query circuitry 110 may be implemented in any number of ways, such as through a hardware-software combination. In some implementations, the query circuitry 110 includes a processor, a memory, or both. The memory may store executable instructions to perform any of the functionality or features of the query circuitry 110 described below.

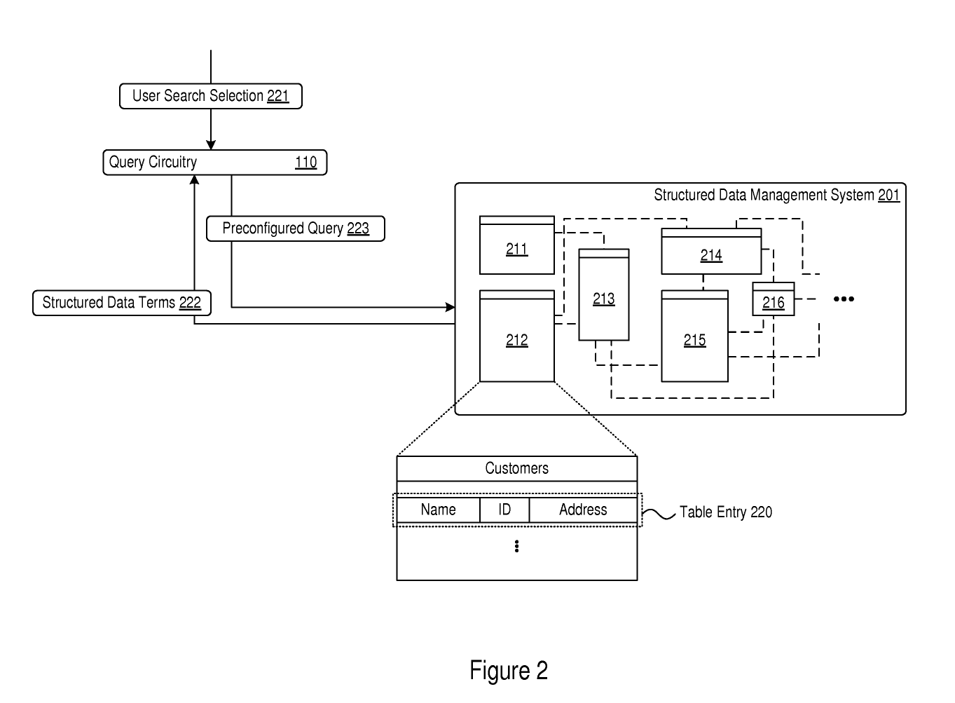

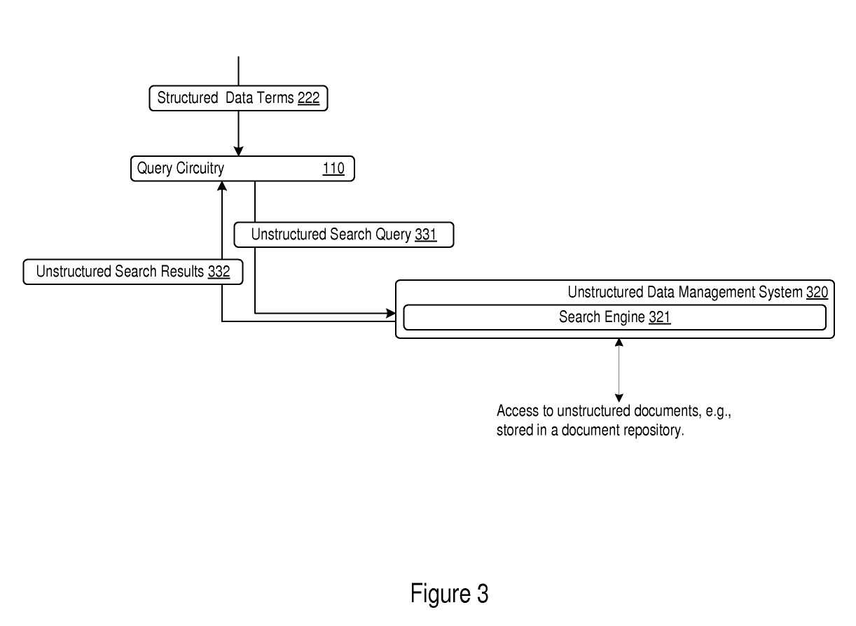

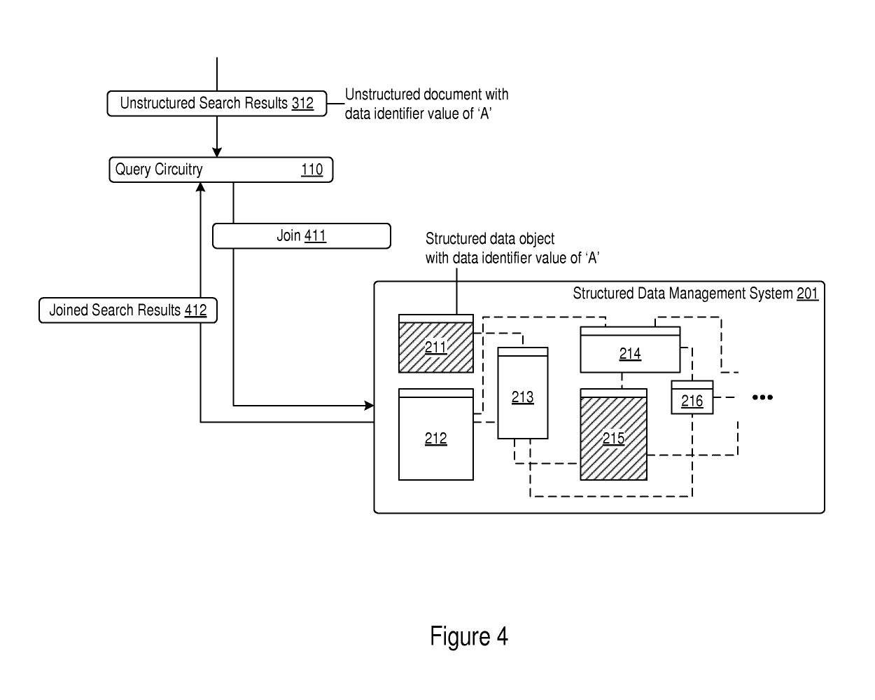

The query circuitry 110 may query for relevant data stored in the data system 100 in various ways using both structured and unstructured data. In some implementations, the query circuitry 110 may utilize structured data to retrieve unstructured data. In these implementations, the query circuitry 110 may generate a search query into an unstructured dataset from a set of data terms obtained from a structured dataset, examples of which are presented through FIGS. 2 and 3. In some implementations, the query circuitry 110 may join search results from an unstructured dataset with selected structured data in the structured dataset, some examples of which are presented through FIG. 4. These example features of the query circuitry 110 are described next.

FIG. 2 shows an example access to a structured dataset that the query circuitry 110 may perform. In the example shown in FIG. 2, the query circuitry 110 access a structured dataset through a structured data management system 201. The structured data management system 201 may be any system, device, logic, or application that controls access to structured data. For example, the structured data management system 201 may be a relational database management system (RDBMS) and the structured data stored through the structured data management system 201 may take the form of a relational database. Referring again to the example In FIG. 2, the structured dataset managed by the structured data management system 201 includes the tables labeled as 211-216, which may be interlinked and organized as specified through a database schema. A table in the structured dataset may include data fields and table entries. An entry in a table may refer to a row of data in the table storing values for the data fields of the table. For example, the table 212 in FIG. 2 is named “Customers” and includes a table entry 220 storing particular values for the “name”, identification “ID”, and “address” data fields.

The query circuitry 110 may be implemented as part of a data system 100 designed to provide access to a specific collection of structured and/or unstructured data. In that regard, a data schema used to organize a structured dataset may correspond to the specific data collection maintained by the data system 100. As one example, the data system 100 may provide searching capabilities for documents of a corporation, and the schema defining the structured dataset managed by the structured data management system 201 may define, as examples, tables storing data for customers, financial transactions, account balances, expenditures, tax data, and more. As another example, the data system 100 may provide searchable access to video data of a sporting event, and the schema defining the structured dataset may thus define tables storing data for players, teams, sponsors, match times, scores and statistics, and more.

The query circuitry 110 may receive a user search selection 221 to access structured and/or unstructured data. The user search selection 221 may be selected from a set of predetermined terms, e.g., through a user interface. The data system 100 may provide the predetermined terms to support selections relevant to the data accessible through the data system 100. Accordingly, the predetermined terms may be presented as a drop-down menu, selectable tabs, buttons, or through other visual indicia presented through the user interface. The user search selection 221 may specify a filter for a specific data type relevant to the data system 100, some examples include filtering for customer data, financial transactions data, team data, player data, or any other type of data supported by the data system 100. The user search selection 221 may specify multiple filters, such as a filter for a data type as well as a temporal filter (e.g., data for a particular time period) or any other additional filter.

The query circuitry 110 may retrieve a set of structured data terms 222 from a structured dataset to support access to a particular type of data. Structured data terms may refer to data terms from a structured dataset, which may be particular values stored in the structured dataset. Thus, structured data terms may include data field values for particular tables in a relational database. The retrieved set of one or more structured data terms may be particularly relevant to a data type, and thus vary depending on a received user search selection 221. In particular, the retrieved set of structured data terms may correspond to a specific data type in the filter specified in the user search selection 221 and vary depending on the specific data type specified by the user search selection 221.

To support retrieval of the set of structured data terms 222 relevant to a specific data type of a user search selection 221, the query circuitry 110 may execute a preconfigured query 223 on the structured dataset. Execution of the preconfigured query 223 on the structured dataset may return the set of structured data terms 222. The query circuitry 110 may select the preconfigured query 223 from among a set of preconfigured queries depending on the particular data type specified by the user selection filter. Put another way, the preconfigured query 223 selected by the query circuitry 110 may vary depending on the user search selection 221. The query circuitry 110 may maintain a set of preconfigured queries that vary according to a corresponding data type. The preconfigured queries may take the form of a Structured Query Language (SQL) query for accessing the structured dataset. The preconfigured queries may depend on the particular schema used to define the structured dataset, and may specify access to particular tables, data fields, keys, or other data stored in the structured dataset specific to the data type specified by the user search selection 221.

A preconfigured query 223 maintained by the query circuitry 110 may be generated according to a predefined business rule. The predefined business rule may identify particular data as relevant to a specific data type corresponding to the preconfigured query 223. Accordingly, the preconfigured query 223 may be generated to specifically account for the schema of the structured dataset to access the particular data fields corresponding to the relevant data specified by the predefined business rule. As one illustration, a predefined business rule may particularly identify a customer name, related corporations, and address as relevant to a “customer” data type. The preconfigured query 223 may be generated to access particular data fields in the structured dataset to retrieve the relevant data specified by the predefined business rule. Accounting for the schema of the structured dataset, the preconfigured query 223 may include any number of select operations, table join operations, or other data access operations to retrieve the relevant data as the set of structured data terms 222. The preconfigured query 223 may be generated or configured by, for example, an application developer, database management entity, or data architect to leverage business knowledge of relevant data and specifically retrieve structured data terms relevant to particular data type according to the predefined business rule.

The predefined business rule may specify a degree to which data is relevant to a specific data type corresponding to the preconfigured query 223. The query circuitry 110 may, for example, determine a weight for a structured data term among the structured data terms 222 returned by executing the preconfigured query 223. In some implementations, entries in the structured dataset may store weight values for particular data fields. In this example implementation, a table in a relational database may include a weight data field specifying the weight of one or more other data fields stored in the table. In some implementations, the preconfigured query 223 itself may include a weight for a structured data term, which may be encoded into the preconfigured query 223.

The weight of a particular data field in the structured dataset may vary depending on the particular data type the query circuitry 110 is accessing, even though the data of the particular data field remains the same. As one illustrative example, a customer “name” data field may have a greater weight for the customer data type and have a lesser weight for the financial transactions data type. In this example, a preconfigured query specific to the customer data type may encode or return a greater weight for the customer “name” data field and the preconfigured query specific to the financial transactions data type may encode or return a lesser weight for the customer “name” data field. In some implementations, the preconfigured query 223 applies a lesser or no weight to numerical data fields.

As described above, the query circuitry 110 may obtain a set of structured data terms 222 from the structured dataset by executing a preconfigured query 223 on the structured dataset. The set of structured data terms 222 retrieved by the query circuitry 110 may vary depending on a user search selection 221 received by the query circuitry 110. The query circuitry 110 may then access unstructured data using the set of structured data terms 222.

FIG. 3 shows an example access to an unstructured dataset that the query circuitry 110 may perform. In some examples, an unstructured dataset is implemented as a document repository storing unstructured documents. The document repository may be accessible and managed through an unstructured data management system 320. The unstructured data management system 320 may control the access and searching of unstructured documents in the document repository. In some examples, the unstructured data management system 320 includes a search engine 321, which may search for one or more keywords among unstructured documents in a document repository. Results returned from a search into the unstructured dataset may be referred to as unstructured search results, which may include one or more unstructured documents returned by the search. The search engine 321 may thus perform a search query into the document repository and return unstructured search results as one or more relevant unstructured documents returned by the search query.

The query circuitry 110 may generate an unstructured search query 331, which may refer to a search query into the unstructured dataset. In particular, the query circuitry 110 may generate an unstructured search query 331 from the set of structured data terms 222 retrieved from the structured dataset. In some examples, the query circuitry 110 applies an unstructured query generation function to the set of structured data terms 222, which generates the unstructured search query 331. The unstructured query generation function may take the set of structured data terms 222 as an input and output an unstructured search query 331 in a format supported by the unstructured data management system 320, for example according to any of methods and techniques described below.

In some examples, the query circuitry 110 itself generates the unstructured search query 331. The query circuitry 110 may populate search terms in the unstructured search query 331 with the structured data terms, thus ensuring that the relevant terms specified by the predefined business rules are searched for in the unstructured dataset. The query circuitry 110 may generate the unstructured search query 331 specifically for input into the search engine 321. Accordingly, the query circuitry 110 may generate the unstructured search query 331 in a syntax supported by the search engine 321.

The query circuitry 110 may account for a weight of a structured data term when generating the unstructured search query 331. When the set of structured data terms 222 includes weights for one or more of the structured data terms, the query circuitry 110 may account for the respective weights when generating the unstructured search query 331. When the syntax of the search engine 321 supports applying a weight to a key word (e.g., search term) in a query, the query circuitry 110 may do so accordingly. When the syntax of the search engine 321 does not support applying a weight to search terms in the query, the query circuitry 110 may adjust the unstructured search query 331 to implicitly include weighting for a particular search term, for example by duplicating a search term multiple times in the unstructured search query 331 to implicitly weight the duplicated term.

In some examples, the query circuitry 110 applies a weighting criterion when generating the unstructured search query 331. For example, the query circuitry 110 may apply a minimum weight threshold when generating the unstructured search query 331. In these examples, the query circuitry 110 includes a particular structured data term as a key word in the unstructured search query 331 when the respective weight of the particular structured data term exceeds the minimum weight threshold. However, the query circuitry 110 may omit the particular structured data term from the unstructured search query 331 when the respective weight does not exceed the minimum weight threshold. In some examples, the query circuitry 110 applies a maximum weight threshold to exclude structured data terms from the unstructured search query 331 when the respective weight of the structured data term exceeds the maximum weight threshold.

Upon generating the unstructured search query 331, the query circuitry 110 may execute the unstructured search query 331 on an unstructured dataset. For example, the query circuitry 110 may communicate the unstructured search query 331 to the unstructured data management system 320 to execute to retrieve unstructured data. The query circuitry 110 may receive unstructured search results 332 as a result of execution of the unstructured search query 331. The unstructured search results 332 may include unstructured documents returned by the search engine 321 that include one or more of the structured data terms 222. The unstructured search results 332 may be ordered according to relevance, which the search engine 321 may determine according to various factors such as degree to which an unstructured document includes a particular structured data term, a weight specified in the unstructured search query 331, or other relevance factors applied by the search engine 321.

The query circuitry 110 may thus receive unstructured data (e.g., the unstructured search results 332) returned from an unstructured search query 331 generated using structured data (e.g., the structured data terms 222). By retrieving unstructured data through use of structured data, the query circuitry 110 may support data searching with increased accuracy, relevancy, and efficiency. Additionally, as the predefined business rules used to generate the preconfigured query 223 may identify specifically relevant data in the structured dataset, the unstructured search results 332 obtained by the query circuitry 110 may provide accurate, relevant results for a user search selection 221. In some examples, the query circuitry 110 returns the unstructured search results 332 to a user, e.g., by presenting the unstructured search results 332 through a user interface. In other examples, the query circuitry 110 may join the unstructured search results 332 with additional structured data to further identify relevant data from the structured dataset, unstructured dataset, or both.

FIG. 4 shows an example data joining that the query circuitry 110 may perform. In particular, the query circuitry 110 may receive unstructured search results 322 and join the unstructured search results 322 with selected structured data in the structured dataset. For example, the query circuitry 110 may execute a join instruction 411 to join selected structured data from the structured dataset to obtain joined data 312. The query circuitry 110 may select, for joining, structured data that corresponds to one or more unstructured documents in the unstructured search results 332. In doing so, the query circuitry 110 may identify structured data that corresponds to an unstructured search result in various ways, examples of which are presented next.

In some examples, the query circuitry 110 may match a data identifier value of an unstructured search result with a data identifier value of a structured data object. An unstructured search result, such as an unstructured document, may include one or more associated data identifier values. The associated data identifier value may be included as part of the metadata for the unstructured document. A structured data object, such as a table, entry, data field, or other element of the structured data may likewise include a data identifier value. The data identifier may be a data field in a table, part of metadata maintained by the structured data management system 201, or otherwise associated with a structured data object in any number of ways. These data identifier values may be referred to as a global identifier or a universal identifier value as they apply across both structured and unstructured datasets.

Matching data identifier values may indicate that an unstructured document and a structured data object correspond to one another. The unstructured document and the structured data object may correspond to common input data that was analyzed and a portion of which was inserted into the structured dataset, the unstructured dataset, or both. As one illustration, input data being inserted into the data system 100 may include a particular e-mail message. Analysis of the e-mail message may result in insertion of a structured data object into the structured dataset, such as a table entry into a “communications” table storing the date, sender, and recipient with respect to the particular e-mail message. The particular e-mail message itself may be identified as unstructured data and indexed by a search engine 321 for storage. A common data identifier value may be generated and associated with both the e-mail message and the table entry into the “communications” table for the e-mail message. Thus, when the search engine 321 subsequently returns the e-mail message as part of the unstructured search results 332, the query circuitry 110 may match data identifier values to identify the entry in the “communications” table as corresponding structured data.

One example of matching data identifier values is shown in FIG. 4. In FIG. 4, the unstructured search results 332 include an unstructured document with a data identifier value of ‘A’. The table 211 in the structured dataset managed by the structured data management system 201 also includes a structured data object (e.g., table entry or the table itself) with a data identifier value of ‘A’. Thus, in FIG. 4, the query circuitry 110 identifies the table 211 as selected structured data with a matching identifier value, and joins the table 211 to the unstructured search results 332 to obtain joined data 412 that includes structured data from the table 211.

In some examples, the query circuitry 110 may identify additional data objects in the structured as corresponding structured data, even when the additional data objects to not have a matching data identifier value with an unstructured search result. As one example, the query circuitry 110 may identify a foreign key in the corresponding table with a matching data identifier value (e.g., the table 211). The query circuitry 110 may further join another table in the structured dataset having the identified foreign key as its primary key. As another example, the query circuitry 110 may perform a self-join on structured data in a table, for example according to a temporal constraint (e.g., a particular time period), a spatial or positioning constraint (e.g., unstructured data in a particular position, space, area, or other part of an unstructured document), or across any other characteristic, data field, or dimension of a structured data object. As yet another example, the query circuitry 110 may identify corresponding or correlated fact tables or dimension tables to a matching structured data object (e.g., via foreign key relationships).

The query circuitry 110 may control which particular structured data is selected for joining through the join instruction 411. In that regard, the query circuitry 110 may generate the join instruction 411 to specify which selected structured data is to be joined with the unstructured search results 332. The joined data 412 may include a structured data objects with a matching data identifier (e.g., the table 211 in FIG. 4), structured data without a matching data identifier but otherwise corresponding to one or more unstructured search results (e.g., the table 215 in FIG. 4, which may share a foreign-primary key relationship with the table 211), or both. The query circuitry 110 may present the joined data 412 through a user interface and/or perform an analysis on the joined data 412.

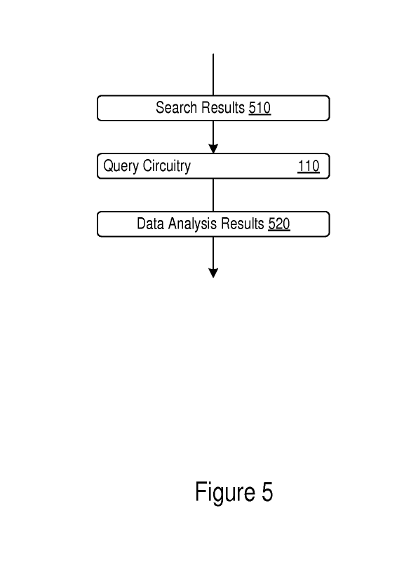

FIG. 5 shows an example of data analysis that the query circuitry 110 may perform. The query circuitry 110 may receive search result data 510, which may include any combination of the unstructured search results 332, the joined data 412, and any other structured or unstructured data the query circuitry 110 may analyze. The query circuitry 110 may analyze the search result data 510 to obtain data analysis results 520.

The query circuitry 110 may perform various join, aggregate, or compute operations on the search result data 510 as part of the data analysis. As one example, the query circuitry 110 may analyze the search result data to determine the number of times a particular term appears, which may be referred to as a count for the particular term. As another example, the query circuitry 110 may perform a group-by count operations to group the search result data 510 according to a specified grouping and perform a count of results for each grouping. The query circuitry 110 may group the search result data 510 according to a data type specified by a user search selection 221, e.g., grouping the search result data by particular teams in a sporting event, and determining a respective count that the various teams appear in the search result data 510. As yet another example, the data analysis performed by the query circuitry 110 may include filtering the search result data 510 for a particular time period, spatial constraint, or across any other data dimension or characteristic, and performing a subsequent analysis on the filtered data.

While some example analyses have been described, the query circuitry 110 may perform any number of other data analysis techniques as part of the data analysis to obtain the data analysis results 520. The query circuitry 110 may present the data analysis results 520 through a user interface, which may provide results for a user search selection 221 input by a user.

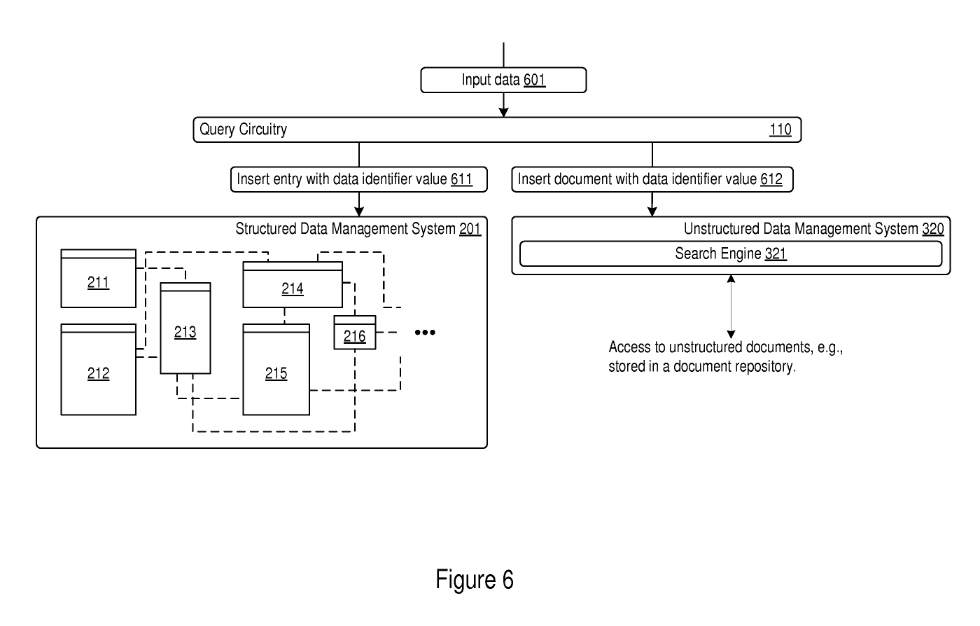

FIG. 6 shows an example of a data insertion the query circuitry 110 may perform. The query circuitry 110 may support analysis and insertion of input data 601 into the data system 100. The input data 601 may be any data that the data system 100 may store, analyze, or support access to. In that regard, the input data 601 may vary depending on the particular functionality or purpose of the data system 100. In some examples, the input data 601 includes business records and documents for a corporation, and may thus include e-mail messages, financial transaction records, legal documents, organizational spreadsheets, and more. In some examples, the input data 601 may include video data for a particular video analysis performed by the data system 100, examples of which include tracking video of a sports team or event, analyzing news events across multiple geographical locations, or determining the effectiveness of product placement across television programs.

The analyses, methods, and techniques the query circuitry 110 may employ to analyze the input data 601 are nearly limitless. For instance, the query circuitry 110 may perform optical character recognition (OCR) to extract text from the input data 601, which may include identifying position data associated with the text (e.g., position in a document or video frame at which the text occurs, timing information for when the text occurs, etc.), time data (e.g., a time record of when the particular text occurs), or other data. The query circuitry 110 may transcribe an audio portion of a video file into text, and further perform a text analysis of the transcription to identify the occurrence of particular terms. As yet another example, the query circuitry 110 may perform facial recognition techniques to identify persons appearing in video data, which may link to the audio transcript during which the facial recognition identifies a particular person. These are just some examples of the analysis the query circuitry 110 may perform on input data 601.

Analysis of the input data 601 may result in structured data for insertion into a structured dataset. That is, the query circuitry 110 may identify specific data extracted from the input data 601 to insert into the structured dataset, which may vary depending on a particular schema or data model of the structured dataset. The query circuitry 110 may, for example, determine to insert a table entry into a relational database managed by the structured data management system 201. The table entry may result from analysis of a particular unstructured document or portion thereof (e.g., a particular video frame or sequence of video frames, a particular e-mail message, a particular spreadsheet, etc.) Accordingly, the query circuitry 110 may identify a correspondence between a structured data object (e.g., the table entry for insertion) and the unstructured document originating the structured data object.

The query circuitry 110 may obtain a commonly generated data identifier value for a structured data object and unstructured document that correspond to one another. The data identifier value may be commonly generated through the insertion process of input data 601. As seen in the example of FIG. 6, the query circuitry 110 sends an insert instruction for a table entry with a data identifier value (instruction 611) to the structured data management system 201. In FIG. 6, the query circuitry 110 sends an insert instruction for a corresponding unstructured object also with the data identifier value (instruction 612).

The query circuitry 110 may obtain the data identifier value to corresponding structured and unstructured data in various ways. In some examples, the query circuitry 110 itself generates the data identifier value. In some examples, the query circuitry 110 receives a data identifier value from the unstructured data management system 320, which may be generated by the search engine 321. In these examples, the search engine 321 may generate and insert the data identifier value into the metadata for an unstructured document. The query circuitry 110 may receive the data identifier value associated with the unstructured document, and insert the data identifier value with data structure objects associated with (e.g., originating or determined from) analysis of the unstructured document. In some examples, the query circuitry 110 receives a data identifier value generated by the structured data management system 201 (e.g., a RDBMS) and sends the associated data identifier value(s) when sending the unstructured document to the search engine 321 for indexing and storage.

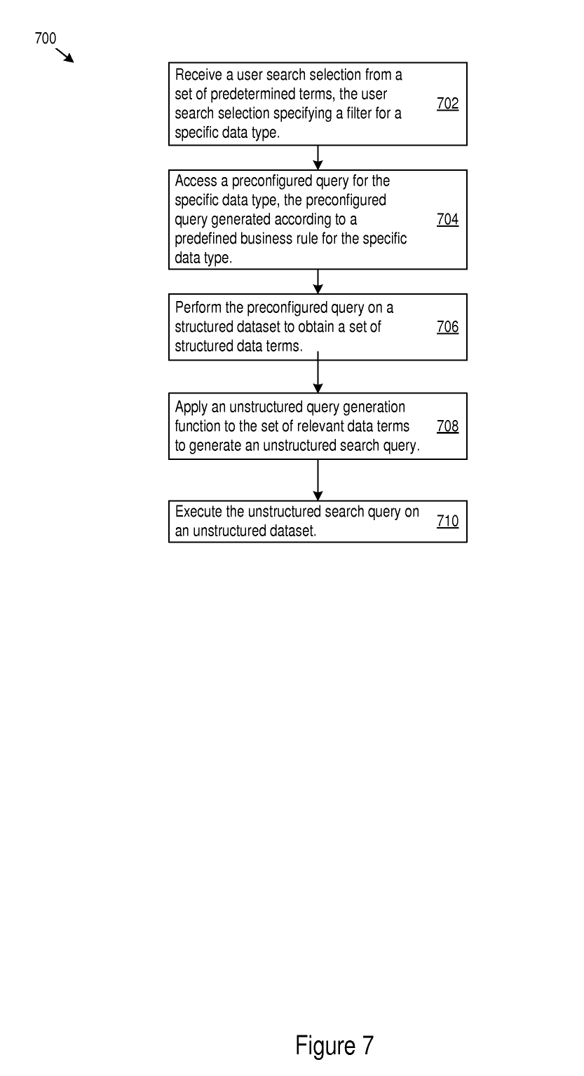

FIG. 7 shows an example of logic 700 that the query circuitry 110 may implement. The query circuitry 110 may implement the logic 700 as hardware, software, or a combination of both, for example as a machine readable medium storing processor executable instruction.

The query circuitry 110 may receive a user search selection 221 from set of predetermined terms, the user search selection 221 specifying a filter for a specific data type (702). In response, the query circuitry 110 may access a preconfigured query 223 for the specific data type, the preconfigured query 223 generated according to a predefined business rule for the specific data type (704). Then, the query circuitry 110 may perform the preconfigured query 223 on a structured dataset to obtain a set of structured data terms 222 (706) and apply an unstructured query generation function to the set of structured data terms 222 to generate an unstructured search query 331 (708). The query circuitry 110 may execute the unstructured search query 331 on an unstructured dataset, for example by sending the unstructured search query 331 to a search engine 321 for execution.

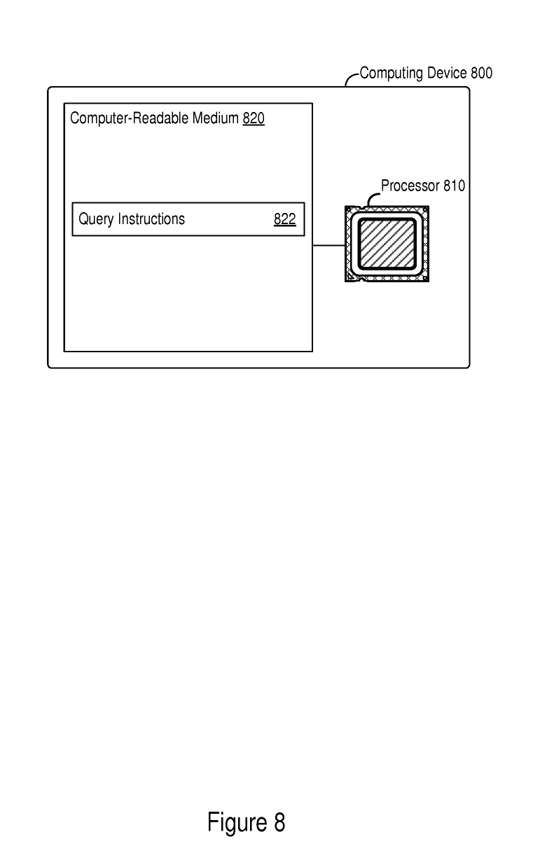

FIG. 8 shows an example of a computing device 800 that supports accessing of structured data, unstructured data, or both. In that regard, the computing device 800 may implement any of the functionality described herein, including any functionality of the query circuitry 110 described above. The computing device 800 may include a processor 810. The processor 810 may be one or more central processing units (CPUs), microprocessors, and/or any hardware device suitable for executing instructions stored on a computer-readable medium (e.g., a memory). The computing device 800 may include a computer-readable medium 820. The computer-readable medium 820 may be any electronic, magnetic, optical, or other physical storage device that stores executable instructions, such as the query instructions 822 shown in FIG. 8. Thus, the computer-readable medium 820 may be, for example, Random Access Memory (RAM), an Electrically-Erasable Programmable Read-Only Memory (EEPROM), a storage drive, an optical disk, and the like.

The computing device 800 may execute instructions stored on the computer-readable medium 820 through the processor 810. Executing the instructions may cause the computing device 800 to perform any of the features described herein. One specific example is shown in FIG. 8 through the query instructions 822. Executing the query instructions 822 may cause the computing device 800 to perform any combination of the functionality of the query circuitry 110 described above, such as maintain a set of preconfigured queries that vary according to a corresponding data type, the preconfigured queries respectively generated according to a predefined business rule for the corresponding data type; receive a user search selection 221 from set of predetermined terms, the user search selection 221 specifying a filter for a specific data type; identify a particular preconfigured query 223 among the set of preconfigured queries according to the specific data type; determine a set of structured data terms 222 relevant to a specific data type by performing the particular preconfigured query 223 on a structured dataset; generate an unstructured search query 331 from the set of structured data terms 222; and execute the unstructured search query 331 on an unstructured dataset to obtain unstructured search results 332.

The methods, devices, systems, and logic described above, including the query circuitry 110, may be implemented in many different ways in many different combinations of hardware, software or both hardware and software. For example, all or parts of the query circuitry 110 may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the circuitry, systems, devices, and logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the systems, devices, and circuitry described herein, including the query circuitry 110, may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments have been described, it will be apparent to those of ordinary skill in the art that many more embodiments and implementations are possible.

Some example implementations have been described. Additional or alternative implementations are possible.

1. A method comprising:
receiving a user search selection from set of predetermined terms, the user search selection specifying a filter for a specific data type;
accessing a preconfigured query for the specific data type, the preconfigured query generated according to a predefined business rule for the specific data type;
performing the preconfigured query on a structured dataset to obtain a set of structured data terms;
applying an unstructured query generation function to the set of structured data terms to generate an unstructured search query; and
executing the unstructured search query on an unstructured dataset.

2. The method of claim 1, wherein executing the unstructured search query on the unstructured dataset comprises inputting the unstructured search query into a search engine for the unstructured dataset; and
wherein applying the unstructured query generation function generates the unstructured search query in a syntax supported by the search engine.

3. The method of claim 1, wherein performing the preconfigured query on the structured dataset comprises performing preconfigured query operations on a set of preconfigured tables in the structured dataset.

4. The method of claim 1, wherein the preconfigured query varies depending on the specific data type.

5. The method of claim 1, wherein performing the preconfigured query on a structured dataset further comprises retrieving a respective weight for one or more terms in the set of structured data terms; and
wherein applying the unstructured query generation function to the set of structured data terms comprises accounting for the respective weight.

6. The method of claim 1, further comprising:
obtaining unstructured search results from performing the unstructured search query on the unstructured dataset; and
analyzing the unstructured search results by performing an aggregate function on the unstructured search results.

7. A system comprising:
query circuitry to:
determine a set of structured data terms relevant to a specific data type by performing a preconfigured query for the specific data type on a structured dataset, the preconfigured query generated according to a predefined business rule for the specific data type;
generate an unstructured search query from the set of structured data terms; and
execute the unstructured search query on an unstructured dataset to obtain unstructured search results.

8. The system of claim 7, wherein the query circuitry is further to join the unstructured search results to selected structured data in the structured dataset.

9. The system of claim 7, wherein the query circuitry is further to:
determine a data identifier value for the unstructured search results;
identify a structured data object in a structured dataset also having the data identifier value;
obtain joined data by joining the unstructured search results from the unstructured dataset with the structured data object from the structured dataset; and
perform an analysis on the joined data.

10. The system of claim 9, wherein the query circuitry is to obtain the joined data further by:
identifying a foreign key in the structured data object;
identifying another structured data object in the structured dataset, the another structured data object having a primary key that is the foreign key; and
joining the another structured data object with the unstructured search results and the structured data object.

11. The system of claim 9, wherein the data identifier value for the unstructured search results and the structured data object was generated through a data insertion process of input data into the structured dataset and the unstructured dataset.

12. A non-transitory computer readable medium comprising executable instructions to:
maintain a set of preconfigured queries that vary according to a corresponding data type, the preconfigured queries respectively generated according to a predefined business rule for the corresponding data type;
receive a user search selection from set of predetermined terms, the user search selection specifying a filter for a specific data type;
identify a particular preconfigured query among the set of preconfigured queries according to the specific data type;
determine a set of structured data terms relevant to a specific data type by performing the particular preconfigured query on a structured dataset;
generate an unstructured search query from the set of structured data terms; and
execute the unstructured search query on an unstructured dataset to obtain unstructured search results.

13. The non-transitory computer readable medium of claim 12, wherein the executable instructions are further to:
determine a data identifier value for the unstructured search results;
identify a structured data object in a structured dataset also having the data identifier value;
obtain joined data by joining the unstructured search results from the unstructured dataset with the structured data object from the structured dataset; and
perform an analysis on the joined data.

14. The non-transitory computer readable medium of claim 13, wherein the executable instructions are further to obtain the joined data by:
identifying a foreign key in the structured data object;
identifying another structured data object in the structured dataset, the another structured data object having a primary key that is the foreign key; and
joining the another structured data object with the unstructured search results and the structured data object.

15. The non-transitory computer readable medium of claim 13, wherein the data identifier value for the unstructured search results and the structured data object was generated through a data insertion process of input data into the structured dataset and the unstructured dataset.
